(19) United States
(12) Patent Application Publication
(10) Pub. No.: US 2005/0273716 A1
(43) Pub. Date: Dec. 8, 2005

(54) Database server paging method

(76) Inventor: Achilles N. Pahno, Douglasville, GA (US)

Correspondence Address: STEPHEN R. LOE, THE LAW OFFICE OF STEPHEN R. LOE, P.O. BOX 649, FRISCO, TX, 75034, US

(21) Appl. No.: 10/860,503

(22) Filed: Jun. 3, 2004

(51) Int. Cl. G06F 17/00

(52) U.S. Cl. 715/733; 715/748; 715/968

(57) ABSTRACT

A method for retrieving data from a database and providing the data to a client is provided. In one embodiment, a server receives a request for data from a client. The request comprises a set of parameters, which in one embodiment comprises three parameters: an SQL SELECT statement, an indication as the number of records per page, and an indication as to the page number of the one page to return. Database server paging software on the server analyzes the set of parameters to determine and create an appropriate page of data. The server then transmits the page of data to the client. Thus, only a single request by the client is necessary and the client is not required to sift through a large key set as in the prior art.

### BACKGROUND OF THE INVENTION

1. Technical Field

The present invention relates generally to computer software and, more particularly, to databases, and even more particularly to retrieving and providing data from databases.

2. Description of Related Art

When an end user has the ability to select a set of records from a database that match certain criteria, the number of records that meet the criteria could be very large. Sending this large set of records to the user's client machine is problematic, because it could take too much time, and the user's machine might not have enough memory to contain the entire set. The solution is to send one page of records from the entire set, and give the user the ability to select any page at random from the entire set.

One common prior art solution to this problem is the stored key method. In this method the primary keys of ALL the selected records are sent to the client. The client displays the selected page by finding the correct set of keys, and re-queries the server with the page of keys to get the rest of the fields for those records. However, the key set returned by the stored key method could be very large. Furthermore, the stored key method requires two requests to the server per page. Therefore, it would be desirable to have a method, system, and computer program product for providing database application programs with the ability to decompose a set of records into a number of pages with an arbitrary number of records per page, and return any one of those pages to a requesting client based on a single request from the client and eliminating or reducing other undesirable aspects of the stored key method.

### SUMMARY OF THE INVENTION

The present invention provides a method for retrieving data from a database and providing the data to a client. In one embodiment, a server receives a request for data from a client. The request comprises a set of parameters, which in one embodiment comprises three parameters: an SQL SELECT statement, an indication as the number of records per page, and an indication as to the page number of the one page to return. Database server paging software on the server analyzes the set of parameters to determine and create an appropriate page of data. The server then transmits the page of data to the client. Thus, only a single request by the client is necessary and the client is not required to sift through a large key set as in the prior art.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server is depicted in accordance with the present invention;

FIG. 3 depicts a block diagram of a data processing system in which the present invention may be implemented;

### DETAILED DESCRIPTION OF THE PREFERRED EMBODIMENT

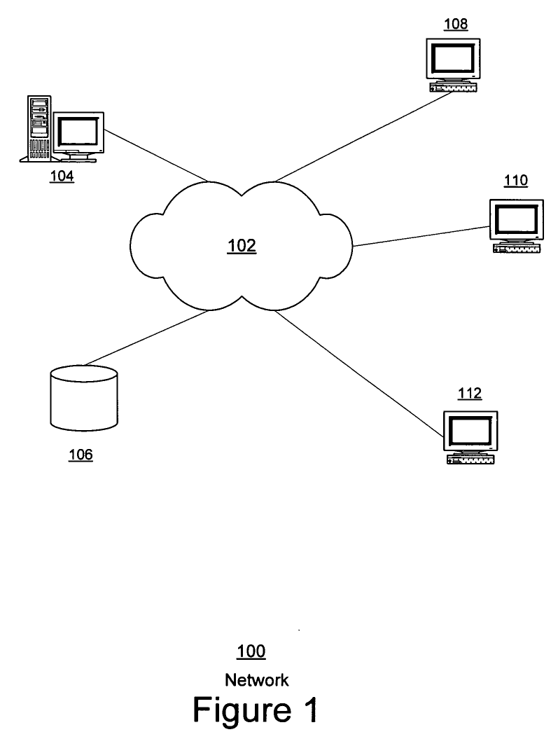

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data from database 106 to clients 108-112. Clients 108, 110 and 112 are clients to server 104. Distributed data processing system 100 may include additional servers, clients, and other devices not shown.

The database server paging system which provides data from database 106 exists, in one embodiment, as one stored procedure on server 104, which in this embodiment is a Structured Query Language (SQL) server. An SQL server is a relational Database Management System (DBMS) server, i.e., a server that controls the organization, storage, retrieval, security and integrity of data in a database. The SQL server accepts requests from applications and instructs the operating system to transfer the appropriate data.

SQL is a language used to interrogate and process data in a relational database. Originally developed by IBM for its mainframes, all database systems designed for client/server environments currently support SQL. SQL commands can be used to interactively work with a database or can be embedded within a programming language to interface to a database. Programming extensions to SQL have turned it into a full-blown database programming language, and all major database management systems (DBMSs) currently support the language.

The client application on any one of clients 108-112 sends parameters to the database server paging system on server 104. The database server paging system then generates a dynamic SQL statement to implement the solution and return the requested page. Although depicted as a separate component, database 106 may be implemented as a component within server 104. The database server paging system of the present invention is descried in more detail below.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet, a local area network (LAN), or a wide area network (WAN). Appropriate security measures, many of which are well known in the art, may also be implemented to protect the privacy and integrity of data retrieved from database 106, such as, for example, encrypting data before transmission and utilization of a virtual private network (VPN).

FIG. 1 is intended as an example and not as an architectural limitation for the processes of the present invention.

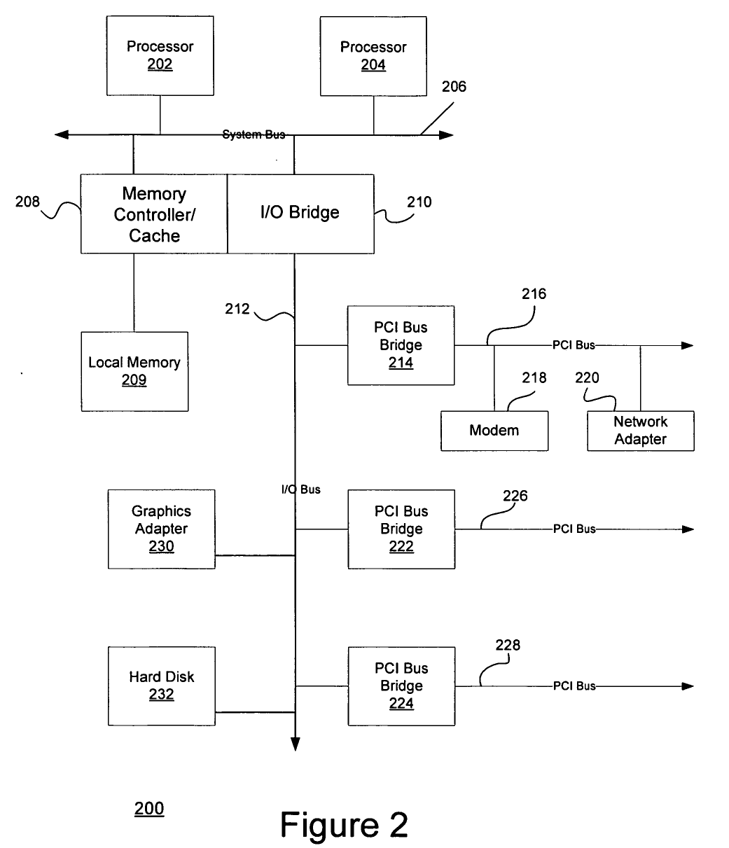

Referring to FIG. 2, a block diagram of a data processing system which may be implemented as a server, such as any one of servers 104-106 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

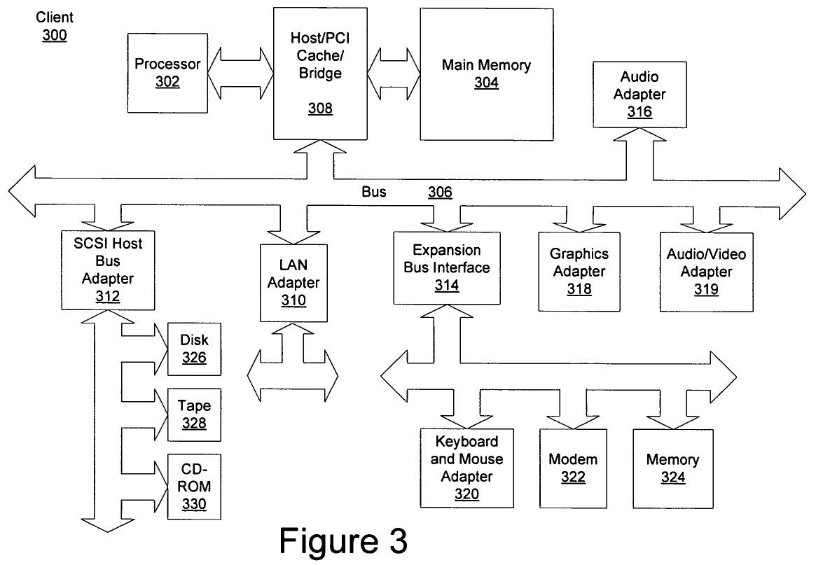

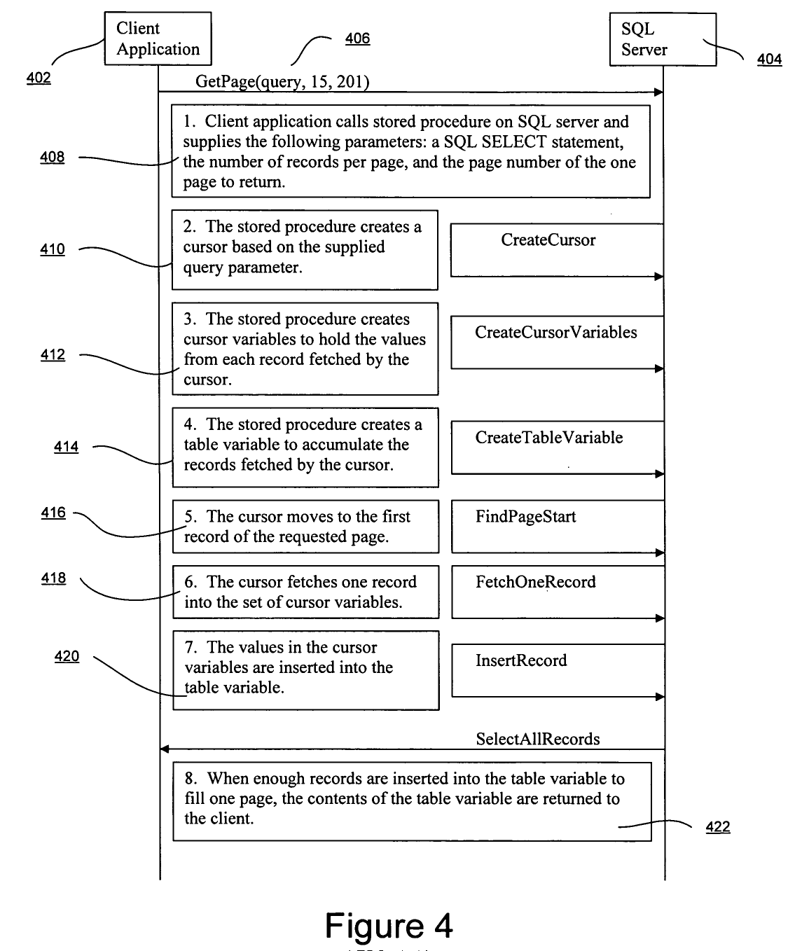

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

With reference now to FIG. 4, a diagram illustrating an exemplary process flow and program function is depicted in accordance with one embodiment of the present invention. In this embodiment, a client application 402, which may be implemented on, for example, data processing system 300 in FIG. 3, calls a stored procedure on SQL server 404, which may be implemented as, for example, server 200 depicted in FIG. 2, and supplies SQL server 404 with the following parameters: a SQL SELECT statement, the number of records per page, and the page number of the one page to return (step 408). An example of a call to the SQL server is GetPage(query, 15, 201) 406, where “query” would be the SQL SELECT statement, “15” the number of records per page, and “201” the page number of the one page to return to client application 402. The database server paging system on SQL server 404 then creates a cursor based on the supplied query parameter (step 410). The database server paging system then creates cursor variables to hold the values from each record fetched by the cursor (step 412).

Next, the database server paging system creates a table variable to accumulate the records fetched by the cursor (step 414). The cursor then moves to the first record of the requested page (step 416). The cursor then fetches one record into the set of cursor variables (Step 418). The values in the cursor variables are inserted into the table variable (step 420). When enough records are inserted into the table variable to fill one page, the contents of the table variable are returned to the client (step 422).

The procedure outlined in FIG. 4 is presented merely as an example of a database server paging system and not as an architectural limitation to the present invention. For example, in other embodiments, in step 414, a temporary table could be used instead of a table variable. This would require the database server paging system to delete the temporary table after it sends the page. However, the creation and deletion of a temporary table is a bit more time consuming than the creation and deletion of a table variable. Other variations and modifications will be apparent to those of ordinary skill in the art.

Thus, the present invention provides that, with a single request to the SQL server, the client application 402 is able to obtain data from a database related to the query of the client and the data is provided in a manageable form of a single page rather than an unmanageable amount of data as in the prior art. Therefore, if the client may peruse the data in the page transferred from the SQL server to determine if that data satisfies the goals of the request and, if not, another page may be obtained from the SQL server. Thus, data transfer from the SQL server to the client is also minimized.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for retrieving data from a database and providing the data to a client, the method comprising:
receiving a request for data from a client, wherein the request comprises a set of parameters;
analyzing the set of parameters to determine an appropriate page of data;
creating the page of data; and
transmitting the page of data to the client.

2. The method as recited in claim 1, wherein the set of parameters comprise a query, an indication of a number of records per page, and an indication as to the page number of the one page to return.

3. The method as recited in claim 2, wherein the query is a structured query language select statement.

4. The method as recited in claim 1, wherein the steps of analyzing and creating comprise:
creating a cursor based on the supplied query parameter; and
creating cursor variables to hold values from each record fetched by the cursor.

5. The method as recited in claim 4, wherein the steps of analyzing and creating further comprise:
creating a table variable to accumulate the records fetched by the cursor;
moving the cursor to the first record of the requested page;
fetching one record into the set of cursor variables; and
inserting the cursor variables into the table variable.

6. The method as recited in claim 5, further comprising:
continuing actions necessary to insert records into the table variable; and
responsive to a determination that enough records have been inserted into the table variable to fill one page, returning the contents of the table variable to the client.

7. The method as recited in claim 4, wherein the steps of analyzing and creating further comprise:
creating a temporary table to accumulate the records fetched by the cursor;
moving the cursor to the first record of the requested page;
fetching one record into the set of cursor variables; and
inserting the cursor variables into the temporary table.

8. The method as recited in claim 7, further comprising:
continuing actions necessary to insert records into the temporary table; and
responsive to a determination that enough records have been inserted into the temporary table to fill one page, returning the contents of the temporary table to the client.

9. A computer program product in a computer readable media for use in a data processing system for retrieving data from a database and providing the data to a client, the computer program product comprising:
first instructions for receiving a request for data from a client, wherein the request comprises a set of parameters;
second instructions for analyzing the set of parameters to determine an appropriate page of data;
third instructions for creating the page of data; and
fourth instructions for transmitting the page of data to the client.

10. The computer program product as recited in claim 9, wherein the set of parameters comprise a query, an indication of a number of records per page, and an indication as to the page number of the one page to return.

11. The computer program product as recited in claim 10, wherein the query is a structured query language select statement.

12. The computer program product as recited in claim 9, wherein the third and fourth instructions comprise:
fifth instructions for creating a cursor based on the supplied query parameter; and
sixth instructions for creating cursor variables to hold values from each record fetched by the cursor.

13. The computer program product as recited in claim 12, wherein the third and fourth instructions further comprise:
seventh instructions for creating a table variable to accumulate the records fetched by the cursor;
eighth instructions for moving the cursor to the first record of the requested page;
ninth instructions for fetching one record into the set of cursor variables; and
tenth instructions for inserting the cursor variables into the table variable.

14. The computer program product as recited in claim 13, further comprising:
eleventh instructions for continuing to insert records into the table variable; and
twelfth instructions, responsive to a determination that enough records have been inserted into the table variable to fill one page, for returning the contents of the table variable to the client.

15. The computer program product as recited in claim 12, wherein the third and fourth instructions further comprise:
seventh instructions for creating a temporary table to accumulate the records fetched by the cursor;
eighth instructions for moving the cursor to the first record of the requested page;
ninth instructions for fetching one record into the set of cursor variables; and
tenth instructions for inserting the cursor variables into the temporary table.

16. The computer program product as recited in claim 15, further comprising:
eleventh instructions for continuing to insert records into the temporary table; and
twelfth instructions, responsive to a determination that enough records have been inserted into the temporary table to fill one page, for returning the contents of the temporary table to the client.

17. A system for retrieving data from a database and providing the data to a client, the system comprising:
first means for receiving a request for data from a client, wherein the request comprises a set of parameters;
second means for analyzing the set of parameters to determine an appropriate page of data;
third means for creating the page of data; and
fourth means for transmitting the page of data to the client.

18. The system as recited in claim 17, wherein the set of parameters comprise a query, an indication of a number of records per page, and an indication as to the page number of the one page to return.

19. The system as recited in claim 18, wherein the query is a structured query language select statement.

20. The system as recited in claim 17, wherein the third and fourth means comprise:
fifth means for creating a cursor based on the supplied query parameter; and
sixth means for creating cursor variables to hold values from each record fetched by the cursor.

21. The system as recited in claim 20, wherein the third and fourth means further comprise:
seventh means for creating a table variable to accumulate the records fetched by the cursor;
eighth means for moving the cursor to the first record of the requested page;
ninth means for fetching one record into the set of cursor variables; and
tenth means for inserting the cursor variables into the table variable.

22. The system as recited in claim 21, further comprising:
eleventh means for continuing to insert records into the table variable; and
twelfth means, responsive to a determination that enough records have been inserted into the table variable to fill one page, for returning the contents of the table variable to the client.

23. The system as recited in claim 20, wherein the third and fourth means further comprise:
seventh means for creating a temporary table to accumulate the records fetched by the cursor;
eighth means for moving the cursor to the first record of the requested page;
ninth means for fetching one record into the set of cursor variables; and
tenth means for inserting the cursor variables into the temporary table.

24. The system as recited in claim 23, further comprising:
eleventh means for continuing to insert records into the temporary table; and
twelfth means, responsive to a determination that enough records have been inserted into the temporary table to fill one page, for returning the contents of the temporary table to the client.

25. A method for retrieving data from a database, the method comprising:
sending a request for data to a server, wherein the request contains a set of parameters indicating the type of data desired and the number of records to return; and
receiving a page of data records from the server.

26. The method as recited in claim 25, wherein the request comprises three parameters.

27. The method as recited in claim 26, wherein the three parameters comprise a query statement, an indication as to the number of records per page, and an indication as to the page number of the one page to return.

28. A computer program product in a computer readable media for use in a data processing system for retrieving data from a database, the computer program product comprising:
first instructions for sending a request for data to a server, wherein the request contains a set of parameters indicating the type of data desired and the number of records to return; and
second instructions for receiving a page of data records from the server.

29. The computer program product as recited in claim 28, wherein the request comprises three parameters.

30. The computer program product as recited in claim 29, wherein the three parameters comprise a query statement, an indication as to the number of records per page, and an indication as to the page number of the one page to return.

31. A system for retrieving data from a database, the system comprising:
first means for sending a request for data to a server, wherein the request contains a set of parameters indicating the type of data desired and the number of records to return; and
second means for receiving a page of data records from the server.

32. The system as recited in claim 31, wherein the request comprises three parameters.

33. The system as recited in claim 32, wherein the three parameters comprise a query statement, an indication as to the number of records per page, and an indication as to the page number of the one page to return.
